(19) United States
(12) Patent Application Publication
(10) Pub. No.: US 2018/0051993 A1
(43) Pub. Date: Feb. 22, 2018

(54) METHOD FOR DETERMINING THE POSITION OF A VEHICLE AND COMPUTER SYSTEM THEREFOR

(71) Applicant: GM GLOBAL TECHNOLOGY OPERATIONS LLC, Detroit, MI (US)

(72) Inventors: Nikolas WAGNER, Ruesselsheim (DE); Maximilian HARR, Ruesselsheim (DE)

(73) Assignee: GM GLOBAL TECHNOLOGY OPERATIONS LLC, Detroit, MI (US)

(21) Appl. No.: 15/678,787

(22) Filed: Aug. 16, 2017

(30) Foreign Application Priority Data
Aug. 16, 2016 (DE) 102016009961.5

(51) Int. Cl. G01C 21/30; G08G 1/01; G01S 19/40

(52) U.S. Cl. CPC G01C 21/30; G01S 19/40; G08G 1/0141; G08G 1/0112

(57) ABSTRACT

A method and system are disclosed to account for improving the accuracy of a calculated position of a vehicle in transit. Position measurement values for different locations are collected. Position measurement values of a plurality of vehicles are collected such that the method is particularly effective in instances, in which dense traffic makes it desirable to determine the position of the vehicles in a particularly accurate fashion. Each position measurement value is allocated to a section of a traffic route. A systematic deviation is estimated based on a comparison of the position measurement values allocated to the section with a reference position. Finally, a position value measured along the traffic route section by the systematic deviation is corrected.

### CROSS-REFERENCE TO RELATED APPLICATION

This application claims priority to German Patent Application No. 102016009961.5, filed Aug. 16, 2016, which is incorporated herein by reference in its entirety.

### TECHNICAL FIELD

The present disclosure pertains to a method for determining the position of a vehicle, as well as to a computer system for carrying out the method.

### BACKGROUND

Satellite navigation systems, which calculate and display the geographic position of a vehicle, into which they are installed, based on radio signals emitted by satellites in Earth's orbit, have become indispensable in road traffic. The function of these navigation systems is based on highly accurate measurements of the transit time of the radio signals. Inhomogeneities of the ionosphere and the troposphere, through which the signals pass on their way from the satellite to the navigation system, affect this transit time unpredictably in the long-term and therefore limit the accuracy of the position calculation to 5-10 m.

Conventional navigation system compensate for this inaccuracy with a plausibility check that is based on map data. The calculated position is compared with positions of traffic routes corresponding to the map data, and the true position of the vehicle is assumed to be a position, which lies adjacent to the calculated position along a traffic route, the course of which matches the route traveled by the vehicle thus far. The accuracy of such a method is not desirable for autonomous driving because it is difficult to determine the lane of a multi-lane traffic route, in which the vehicle is located.

U.S. Pat. No. 8,972,175 B2 discloses a method, in which the navigation of an own or ego-vehicle is improved with the aid of data collected from other vehicles. Such data can provide information, e.g., on a closed traffic lane, a traffic jam, etc. and assist in preventing a driver from being surprised by such an obstacle. However, the collected data does not contribute to improving the accuracy of the position measurement of the ego-vehicle.

Accordingly, there is a need to develop a method that makes it possible to improve the quality of the position measurement of an ego-vehicle with the aid of data collected by other vehicles.

### SUMMARY

According to an embodiment of the present disclosure, a method for determining the position of a vehicle is provided that includes: collecting position measurement values obtained at different locations; allocating each position measurement value to a section of a traffic route; estimating a systematic deviation based on a comparison of the position measurement values allocated to the section with a reference position; and correcting a position value measured along the traffic route section by the systematic deviation.

Measuring errors caused by Inhomogeneities of the upper atmosphere cannot be predicted over prolonged periods of time because the satellites move relative to the Earth's surface and the path, on which their signals reach a given point on Earth's surface, therefore continuously changes. The disclosed method recognizes that the effect of such measuring errors on measurements carried out in brief succession is essentially identical such that measurements, which are carried out by the navigation systems of different vehicles in rapid succession on the same section of a traffic route, essentially have the same systematic deviation from the true value. If this deviation is known from previous measurements, the position of a subsequent measurement can be improved by correcting this measurement by the systematic deviation.

The thusly achieved improvement increases proportionally to the quantity and the recency of previous measurements used. To this end, position measurement values of a plurality of vehicles should be collected such that the method is particularly effective in instances, in which dense traffic makes it desirable to determine the position of the vehicles in a particularly accurate fashion.

In order to ensure that the collected data can benefit a plurality of vehicles, the collection of the position measurement values should include the transmission of the position measurement values of a plurality of vehicles to a common server that can be accessed by the navigation systems of the vehicles. The server can carry out the estimation of the systematic deviation uniformly for all vehicles using the method.

The position measurement values may be geographic coordinates that already were conventionally calculated by the navigation systems of the participating vehicles from pseudo-ranges of the satellites, which can be received by the respective vehicle. they preferably are the pseudo-ranges or equivalent data, which is specifically measured by the navigation system of the vehicle for each visible satellite and only converted into geographic coordinates by the server.

In this case, the server can respectively estimate the systematic deviation separately for different sets of visible satellites and the navigation system of a vehicle can select the value, which corresponds to the set of satellites visible from this vehicle, from the different values of the systematic deviation for the correction.

Although each position measurement value is received from one individual navigation system, the server should allocate such a position measurement value to a section of a traffic route, i.e. the server should decide on which traffic route section the vehicle equipped with the navigation system is located. Since the server can typically access position measurement values of a plurality of motor vehicles, the local interrelationship between these measurement values enables the server to make this decision with greater reliability than a navigation system that is dependent on its own measurements only.

The determined systematic deviation should be transmitted from the server to a vehicle such that the correction of a position measurement value, which is based on this systematic deviation, can be realized in the motor vehicle. In this way, the corrected position measurement value can be made available with the shortest delay possible. Furthermore, the communication bandwidth required for the method can be reduced due to the fact that the navigation system of the vehicle can use a transmitted systematic deviation for correcting the position measurements until it is replaced with an updated systematic deviation or a predefined validity period of the systematic deviation has expired.

It is conceivable that the systematic deviation is only transmitted to one vehicle, which in turn actively contributes to carrying out the method by delivering position measurement values to the server. The systematic deviation determined for a traffic route section should furthermore only be transmitted to relevant vehicles, i.e. vehicles that are located on or about to reach this traffic route section. For this purpose, radio stations may be distributed in a geographic region, in which the method is implemented. The radio stations respectively broadcast the systematic deviations for traffic route sections located within the geographic region covered by these radio stations.

The systematic deviation may be determined in the form of a vector that optimizes the correspondence of the position measurement values allocated to the traffic route section with the course of the traffic route section. For this purpose, for example, a distance from the known course may be calculated for all position measurement values allocated to a traffic route section or a weighting function such as the amount or square of the distance may be calculated for all position measurement values and added up, wherein the systematic deviation is assumed to be the vector that minimizes the sum if the position measurement values are corrected by this vector.

In the case of a multi-lane traffic route section, the position measurement values may respectively differ by one traffic lane width transverse to the driving direction without thereby deteriorating the measuring accuracy. In order to take this into account, an assumption on the number of traffic lanes of the traffic route section should be made during the determination of the systematic deviation and each position measurement value allocated to the traffic route section should be assigned to a traffic lane.

The assumption may be based on map data that is made available to the method beforehand in the form of input data. However, the number of traffic lanes can also be estimated based on the position measurement values. The position measurement values make it possible to continuously update the map data including the reference position used for determining the systematic deviation.

In order to take into account the continuous motion of the satellites and the atmosphere, the position measurement values allocated to the traffic route section should be weighted in an age-dependent fashion during the determination of the systematic error.

According to another embodiment of the present disclosure, a programmed computer system is configured to carry out a method of the type described above. Such a computer system particularly may include a plurality of vehicle-based computers for generating the position measurement values collected as well as a server on which the method is executed. The present disclosure furthermore pertains to a computer program product with program code that enable a computer system to carry out the above-described method, as well as to a machine-readable data carrier with recorded program instructions that enable a computer to carry out the method.

### BRIEF DESCRIPTION OF THE DRAWINGS

The present disclosure will hereinafter be described in conjunction with the following drawing figures, wherein like numerals denote like elements.

FIG. 1 shows a traffic route that is equipped with the infrastructure required for carrying out the disclosed method;

FIG. 2 shows an enlarged detail of FIG. 1, in which position measurement values of different vehicles and a systematic deviation resulting therefrom are illustrated;

FIG. 3 shows the detail according to FIG. 2, in which position measurement values corrected by the systematic deviation are illustrated; and

FIG. 4 shows a flowchart of the method.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

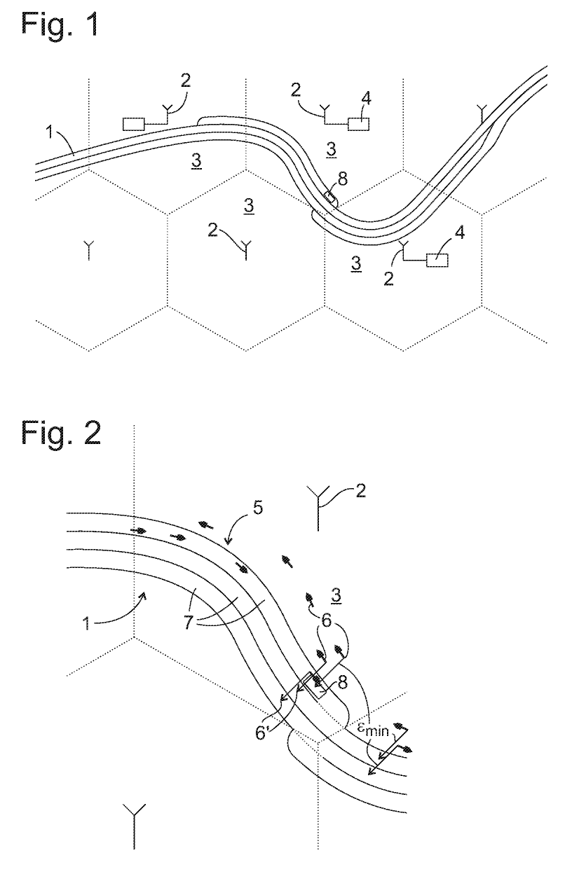

FIG. 1 shows a map section of a geographic region with a traffic route 1, in this case a road that sectionally includes more than two lanes, in the form of an illustration that is not true-to-scale. A cellular network is implemented in the region and includes base stations 2 that respectively cover a surrounding cell 3. The cellular network may be a specialized network for carrying out the method described below. In this case, the base stations typically include radio beacons that are distributed along the traffic route 1. The cellular network preferably operates according to the GSM, UMTS or LTE standard and offers its customers access to Internet services. The further description focuses on this case.

Each vehicle 8 participating in the disclosed method features a navigation system that conventionally calculates the geographic position of the vehicle based on satellite signals and periodically transmits the result to a server 4 via the cellular network. A server 4 may be permanently assigned to each base station 2 and receive the position measurement values from the cell of this base station 2 only. However, a common server 4 may also be provided to collect position measurement values received from a plurality of base stations 2. In the latter instance, an identification of the transmitting base station may be added to each measurement value transmitted to the server such that severely incorrect measurement values, which specify a geographic position outside the cell of the base station, can be sorted out and discarded based on the identifications.

Since the cells 3 are generally so large that they contain sections of multiple traffic routes, information on the cell alone does not suffice for allocating a position measurement value to a traffic route. In order to enable the server 4 to reliably allocate a position measurement to a certain traffic route section, the vehicles transmit information on the driving direction and/or an individual identification of the transmitting vehicle together with each position measurement value. The information on the driving direction enables the server 4 to exclude traffic route sections that do not extend in the indicated driving direction. The vehicle identification makes it possible to associate the current position measurement value with previous measurement values of the same vehicle 8 in order to select a traffic route section, the distance of which from the current position measurement value is as small as possible and which is also compatible with the previous measurement values of the same vehicle 8, as the traffic route section on which the vehicle 8 is located.

The server 4 continuously receives position measurement values from all vehicles that participate in the method and travel within the region covered by the server. All these position measurement values are respectively associated with the time, at which they are generated, and thusly stored in the server 4. However, only position measurement values that were identified as originating from vehicles on the traffic route 1 subsequently have to be analyzed.

The position measurement values may be geographic coordinates that already were conventionally calculated by the navigation systems of the participating vehicles from pseudo-ranges of the satellites, which can be received by the respective vehicle. they preferably are the pseudo-ranges or equivalent data, which is specifically measured by the navigation system of the vehicle for each visible satellite and only converted into geographic coordinates by the server.

FIG. 2 shows an enlarged detail of a cell 3 and the traffic route 1 extending in this cell in the form of an illustration that is not true-to-scale. The server 4 identifies measurement values, the age of which does not exceed a predefined limit, based on the generating time stored for each position measurement value. Locations 6, which correspond to these position measurement values and were allocated to the traffic route 1 by the server 4, are illustrated in the form of short arrows, the points of which respectively indicate the driving direction of the motor vehicles based on the measurement values. The coordinates (xᵢ, yᵢ), i=1, 2, . . . of the locations 6 do not necessarily correspond to the coordinates of the route section 5 (known by the server 4) because they are subject to a systematic deviation that is as yet unknown, but uniform for all measurement values that were obtained within a sufficiently small geographic region and within a sufficiently short time interval.

For reasons of simplicity, it is assumed below that the cell 3 is sufficiently small for considering the systematic deviation location-independent over the entire section 5 of the traffic route extending through the cell 3 with good approximation. If this is not the case, the traffic route 1 can be divided into multiple sections in the region of the cell 3 and the systematic deviation can be individually determined for each of these sections.

One option for determining the systematic deviation is an adaptation according to the method of least error squares. The error of a measurement value (xᵢ, yᵢ) is assumed to be the distance d between its location 6 and the nearest point of the traffic route 1. The quality of the correspondence between the measurement values and the course of the traffic route can be quantified in the form of the sum of the distance squares divided by the number of measurement values:

$$Q = \frac{1}{n} {\sum }_{i = 1}^{n} {d}_{i}^{2}$$

If all locations are shifted by an identical two-component vector ε=(x,y), the resulting quality function is a function of x and y, namely

$$Q ( x , y ) = \frac{1}{n} {\sum }_{i = 1}^{n} {d ( {x}_{i} + x , {y}_{i} + x )}^{2}$$

and the vector εₘᵢₙ, for which the function Q assumes a minimum, can be determined with known mathematical methods. This vector describes the systematic deviation of the position measurement values 6 from the true positions of the vehicles.

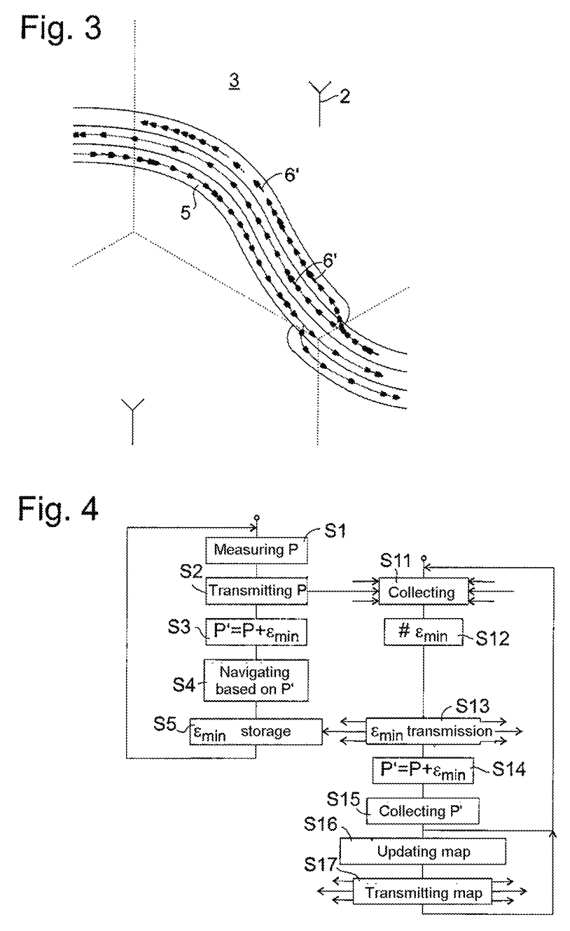

In the idealized case illustrated in FIG. 2, a shift of all locations 6 by the systematic deviation εₘᵢₙ results in the shifted locations 6′ lying on the traffic route 1 as shown in FIG. 3. Since the server 4 repeatedly collects a set of position measurement values 6 over a long period of time, calculates their systematic deviation εₘᵢₙ and corrects the respective position measurement values based on this systematic deviation, the server obtains a large number of corrected locations 6′ that accumulate along the traffic lanes 7 of the traffic route 1 as shown in FIG. 3 and thereby indicate locations, at which the traffic route 1 has multi-lane sections, as well as the number of traffic lanes 7.

The map data accessed by the navigation system of the vehicle 8 should be identical to the map data used by the server. If this data contains information on the number of traffic lanes 7, the navigation system can determine the traffic lane 7 of the multi-lane section 5, on which the vehicle 8 is located, based on the corrected position measurement values and take this into account in the navigation.

As the vehicle 8 travels along the traffic route 1, its navigation system continuously carries out position measurements based on received satellite navigation signals and transmits the thusly obtained position measurement values to the server 4. The server 4 utilizes the position measurement values in the above-described fashion for determining the current systematic deviation εₘᵢₙ of the position measurements along the section 5 of the traffic route 1 currently traveled by the vehicle 8. The result of each new calculation of the systematic deviation εₘᵢₙ is transmitted from the base station 2, in which the section 5 is located, to the vehicles located within the cell 3. The broadcast may take place in encrypted form such that only the navigation systems of vehicles, which are registered for participating in the method and therefore were provided with the required key, are capable of decrypting the transmitted data. The navigation system of the vehicle 8 stores the transmitted value of the systematic deviation εₘᵢₙ and adds this value to each position measurement value in order to obtain a corrected position measurement value until the systematic deviation is updated with another transmission. This corrected position measurement value is used by the navigation system, e.g., for fixing the position of the vehicle 8 on a displayed map, for determining the traffic lane of a potential multi-lane section of the currently traveled traffic route 1, on which the vehicle 8 is located, as well as for potentially suggesting a lane change during the approach of an intersection based on this determination.

FIG. 4 shows the above-described circumstances in the form of a flowchart: the vehicle measures pseudo-ranges of multiple satellites visible from its location at a given time and calculates its current position P based on these pseudo-ranges. The calculated position P deviates from the true position of the vehicle, but the magnitude of this deviation is not necessarily known at that time. The measurement value P is transmitted to the server 4 in step S2. numerous other vehicles located within the geographic region covered by the server 4 likewise transmit their respective measurement values to the server.

The server 4 therefore collects (S11) position measurement values P from a plurality of vehicles traveling on the same traffic route section 5 within a short period of time, calculates (S12) the systematic deviation εₘᵢₙ based on these measurement values P and the known coordinates of the traffic route section 5 and transmits (S13) the result to the vehicles traveling in the cell 3 containing the traffic route section 5.

The navigation system of the vehicle 8 stores (S5) the systematic deviation εₘᵢₙ and therefore is capable of calculating (S3) a corrected position measurement value P′=P+εₘᵢₙ, on which the further tasks of the navigation system are based (S4), no later than at the next repetition of steps S1, S2.

Each time the server has calculated the systematic deviation εₘᵢₙ anew (S12), it likewise applies (S14) the newly calculated systematic deviation to the position measurement values P, on which its calculation was based, and stores (S15) the resulting corrected position values P′. The collection of corrected position values P′ obtained in this way over time forms a map of the course of the traffic route section 5. Since such corrected position values are obtained for all traffic routes in the region covered by the server 4 over time, the server 4 can continuously update the map data, which forms the basis of the calculation of εₘᵢₙ in step S12, and also provide (S17) the navigation system of the vehicle 8 with updated map data. In this way, newly constructed traffic routes are automatically supplemented whereas closed or deconstructed traffic routes can be deleted from the map if no position measurement values of vehicles are allocated thereto over a prolonged period of time.

According to an enhanced variation, the navigation system of the vehicle 8 transmits the set of pseudo-ranges itself rather than the location coordinates of the vehicle 8 calculated from the current set of pseudo-ranges of the satellites visible from the vehicle 8 in step S2 of the method. Since individual satellites may be concealed by buildings, adjacent vehicles or the like, it can occur that a satellite, which is visible from other vehicles that simultaneously travel on the same traffic route section 5, is not visible from the vehicle 8.

Based on such a set of pseudo-ranges, the server not only calculates the position resulting with consideration of all pseudo-ranges of the set, but rather all positions that can be calculated on the basis of a subset of this set.

If G={g₁, g₂, . . . , gₙ) is the set of all satellites gᵢ visible from the traffic route section 5, i.e. the set of satellites, of which the server has in step S11 collected a pseudo-range from at least one vehicle located on the traffic route section 5, a plurality of position measurement values P are obtained for each subset TG of G, which includes sufficient satellites for allowing a position calculation. The calculation of the systematic deviation ε_{min,TG} is carried out for each such subset TG in step S12 and all ε_{min,TG} are broadcast to the vehicles in step S13.

Each vehicle can now select the systematic deviation, which corresponds to the set of satellites currently visible from the vehicle, from this plurality of systematic deviations ε_{min,TG} in order to calculate the corrected position in step S3 and thereby carry out the correction, which is adapted best to its current receiving conditions.

Although the preceding detailed description and the figures concern certain exemplary embodiments of the present disclosure, it goes without saying that they are merely intended for elucidating the present disclosure and should not be interpreted as restrictions to the scope of the present disclosure. The described embodiments can be modified in various ways without thereby deviating from the scope of the following claims and their equivalents.

For example, the quality function Q can be modified in that the amount of the distance Idl is analyzed instead of the distance square d². In addition, different position measurement values can be weighted differently. In the above-described example, all measurement values, the age of which does not exceed a predefined limit, are weighted with 1 and the older measurement values are weighted with 0, but it is alternatively also possible to use a weighting coefficient in the form of a continuously decreasing function of the age.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A method for determining the position of a vehicle along a traffic route, comprising:
collecting position measurement values obtained at different locations;
allocating each position measurement value to a section of the traffic route;
estimating a systematic deviation based on a comparison of the position measurement values allocated to the section with a reference position; and
correcting a position value measured along the traffic route section based on the systematic deviation.

17. The method according to claim 16, further comprising collecting position measurement values obtained from of a plurality of vehicles at different locations.

18. The method according to claim 17, further comprising:
transmitting the position measurement values from the plurality of vehicles to a common server; and
estimating the systematic deviation with the server.

19. The method according to claim 18, further comprising allocating the position measurement value to the section of the traffic route with the server.

20. The method according to claim 18, further comprising transmitting the determined systematic deviation for the traffic route section from the server to a vehicle.

21. The method according to claim 18, further comprising; transmitting the systematic deviation to one of the plurality of vehicles; and correcting the position value for the one vehicle.

22. The method according to claim 18, further comprising transmitting the systematic deviation determined for a traffic route section to one of the plurality of vehicle that is located proximate to the traffic route section.

23. The method according to claim 16 further comprising determining the systematic deviation in the form of a vector that optimizes the correspondence between the position measurement values allocated to the traffic route section and a course of the traffic route section.

24. The method according to claim 23, further comprising:
assigning a number of traffic lanes for the traffic route section; and
allocating each position measurement value for the traffic route section with one of the number of traffic lanes.

25. The method according to one of the preceding claims, in which the reference position is updated based on the position measurement values.

26. The method according to claim 16 further comprising weighting the position measurement values for the traffic route section in a time-dependent manner when determining the systematic deviation.

27. A non-transitory computer readable medium comprising program instructions that, when executed on a computer, are configured to carry out the method according to claim 16.

28. A computer program product comprising the non-transitory computer readable medium of claim 27 and a computer for executing the program instructions.

29. A computer system for determining a corrected position of a vehicle traveling along a traffic route comprising:
a vehicle-based computer configured to collect position measurement values obtained at different locations, and to correcting a position value measured along the traffic route based on a systematic deviation;
a server in communication with the vehicle-based computer configured to allocate each position measurement value to a section of the traffic route, and to estimate the systematic deviation based on a comparison of the position measurement values allocated to the section with a reference position.
